(19) United States
(12) Patent Application Publication
(10) Pub. No.: US 2003/0135560 A1
(43) Pub. Date: Jul. 17, 2003

(54) Routing digital email objects within a client device

(75) Inventors: William Kress Bodin, Austin, TX (US); Derral Charles Thorson, Austin, TX (US)

Correspondence Address: BIGGERS & OHANIAN, PLLC, 5 SCARLET RIDGE, AUSTIN, TX, 78737, US

(73) Assignee: INTERNATIONAL BUSINESS MACHINES CORPORATION, ARMONK, NY

(21) Appl. No.: 10/046,951

(22) Filed: Jan. 15, 2002

(51) Int. Cl. G06F 15/16

(52) U.S. Cl. 709/206; 709/227

(57) ABSTRACT

Email administration including receiving through a transcoding gateway an email message comprising a digital object having a digital object type, the transcoding gateway coupled to a display device, the transcoding gateway including a display device record comprising display format attribute of the display device, wherein the display format attributes include a display format type for the display device. Embodiments include finding a display device record for a destination display device, wherein the destination display device comprises a display device having a display format type that is the same as the digital object type; transcoding the digital object in dependence upon the display format attributes of the destination display device; and displaying the transcoded digital object on the destination display device.

### BACKGROUND OF THE INVENTION

1. Field of the Invention

The field of the invention is data processing or, more specifically, methods, systems, and products for routing digital email objects within a client device.

2. Description of the Related Art

Prior art email allows mail messages to be exchanged between users of computers around the world and out of the world, to space shuttles and the International Space Station. Internet email in particular provides a standard communications mechanism for millions of computers connected to the Internet.

In the early days of email, email messages were very limited in features. They were restricted to ASCII characters; they had maximum line lengths and maximum message lengths. Modem email messages, however, support digital objects comprising audio, video, and graphic images. The modem email standard for the Internet, initiated in 1992, is called ‘MIME,’ an acronym for Multipurpose Internet Mail Extensions. MIME allows mail messages to contain multiple digital objects in a single message, text having unlimited line length or overall length, character sets other than ASCII (allowing non-English language messages), multi-font messages, and binary or application specific files. Digital objects supported in MIME messages include graphic images, audio, video and multi-media messages.

Email messages are delivered to email clients, software application programs capable of connecting to the Internet through mail servers and downloading email messages from electronic mailboxes maintained in email servers. Examples of email clients are Microsoft's well-known email applications called Outlook™ and Outlook Express™.

In current art, email is delivered from email servers to email clients on personal computers. Email clients are often implemented on PDAs, network-enabled cellular telephones, and other devices in the general category of ‘personal computer,’ although, nevertheless, the emails are directed from email servers to email clients on some kind of personal computer. Personal computers are optimized for text display; this is true despite the fact that email clients in some personal computers today are capable of displaying video, graphic images, and audio, because personal computer are just not very good at displaying video, graphic images and audio. Television sets and video monitors are good at displaying video. High fidelity stereo and quadraphonic sound systems are good at displaying audio. High resolution digital art frames are good at displaying graphic images. In current art, however, there is no way to email a digital image to a digital art frame, no way to email a video clip to a television, no way to email a musical performance to a sound system, although it would be beneficial it there were.

### SUMMARY OF THF INVENTION

A method of email administration is disclosed as comprising, in typical exemplary embodiments, receiving through a transcoding gateway an email message, wherein the email message comprises at least one digital object having a digital object type, the transcoding gateway is coupled to one or more display devices, and the transcoding gateway comprises, for each display device, a display device record comprising display format attributes of each display device, wherein the display format attributes include a display format type for each display device. The method includes, in typical exemplary embodiments, finding a display device record for a destination display device, wherein the destination display device comprises a display device having a display format type that is the same as the digital object type; transcoding the digital object in dependence upon the display format attributes of the destination display device; and displaying the transcoded digital object on the destination display device.

In various alternative exemplary embodiments, a transcoding gateway comprises an email client, a web browser, and an HTTP server. In other exemplary embodiments, the client device comprises a display device and a microcomputer, wherein the microcomputer further comprises a transcoding gateway, an email client, a web browser, and an HTTP server, wherein the transcoding gateway, the email client, the web browser, and the HTTP server are coupled for data communications.

In some embodiments, displaying a transcoded digital object on a destination display device further comprises writing the transcoded digital object to display memory. In some embodiments, displaying a transcoded digital object on a destination display device further comprises sending the transcoded digital object to a browser.

The foregoing and other objects, features and advantages of the invention will be apparent from the following more particular description of exemplary embodiments of the invention, as illustrated in the accompanying drawings wherein like reference numbers represent like parts of the invention.

### BRIEF DESCRIPTION OF THE DRAWINGS

FIG. 1 is an overview block diagram of an embodiment including a transcoding gateway.

FIG. 2 is an overview data flow diagram of an example embodiment of a client device comprising a transcoding gateway.

FIG. 3 is an overview data flow diagram of an additional, more detailed example embodiment of a client device comprising a transcoding gateway.

FIG. 4 is an overview data flow diagram of a further, more detailed example embodiment of a client device comprising a transcoding gateway.

FIG. 5 is an overview data flow diagram of a still further, more detailed example embodiment of a client device comprising a transcoding gateway.

FIG. 6 illustrates an example display device record for a PDA.

FIG. 7 illustrates an example display device record for a text-to-speech converter.

FIG. 8 illustrates an example display device record for a text overlay driver.

FIG. 9 illustrates an example display device record for a video display.

FIG. 10 illustrates an example display device record for an audio player.

### DETAILED DESCRIPTION OF EXEMPLARY EMBODIMENTS

### Introduction

The present invention is described primarily in terms of methods for administration of email and particularly in terms of methods for administration of digital objects included in email. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system.

Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Definition

In this specification, the following terms are used as defined here. Other terms are defined elsewhere in the specification and used as defined.

“Digital object” means any data in email other than the text body and format headers of the email itself. Digital objects are said to be “included” in email in the sense that they are transmitted as parts of an email message, often in MIME-compliant settings. The sense in which digital objects are “included” in emails includes both actual integration within an email message as well as inclusion by reference to digital or binary files external to the main body of an email message. Although many embodiments of the present invention utilize MIME-compliant email, there is nothing within the present invention itself that requires MIME-compliance. Many other ways, beyond MIME, of including digital objects in email will occur those of skill in the art, and all such ways are well within the scope of the present invention.

“MPEG” is a standard digital format for video developed by the Moving Picture Experts Group, a working group within the International Standards Organization.

“MP3” is a standard file extension for MPEG, audio layer 3, a standard digital format for audio files.

“JPEG” is a standard digital format for color images developed by the Joint Photographic Experts Group.

“GIF” refers to “Graphics Interchange Format, a standard digital format for bitmapped color images.

“SMTP” means Simple Message Transfer Protocol, referring to the standard protocol for communicating email messages from email clients to email servers and from email servers to other email servers. In is typical in prior art that SMTP is used to communicate email messages from source email clients to mailbox locations, and POP is then used to communicate the email messages from mailboxes to destination email clients.

“POP” means Post Office Protocol, referring to the standard protocol for communicating email messages from email servers to email clients. “POP3” is a standard Post Office Protocol capable of communicating email messages among email servers and both to and from email clients, which means that POP3 is now useful as a single email protocol with no need for SMTP.

In this specification, the terms “field,”. “data element,” and “attribute” are used as synonyms, referring to individual elements of digital data. Aggregates of data elements are referred to as “records” or “data structures.” Definitions of complex data structures that include member methods, functions, or software routines in addition to data elements are referred to as “classes.” Instances of complex data structures are referred to as “objects” or “class objects.”

“Browser” means a web browser, a software application for locating and displaying web pages. Typical browsers today can display text, graphics, audio and video.

“Client device” refers to any device capable of coupling for data communications to a transcoding gateway. Examples of client devices are personal computers, internet-enabled special purpose devices, internet-capable personal data administrators, and others that will occur to those of skill in the art. Various embodiments of client devices are capable of wired and/or wireless couplings to transcoding gateways. The use as a client device of any instrument capable of accessing a server through a network is well within the present invention.

“LAN” means local area network.

“Network” is used in this specification to mean any networked coupling for data communications. Examples of networks useful with the invention include intranets, extranets, internets, local area networks, wide area networks, and other network arrangements as will occur to those of skill in the art. The use of any networked coupling from client devices to one or more transcoding gateway servers is well within the scope of the present invention.

“Server” in this specification refers to a computer or device comprising automated computing machinery on a network that manages network resources. In this sense, transcoding gateways in some embodiments are servers that manage network traffic; in some embodiments of the present invention, such network traffic includes email messages, HTML documents, and digital objects. Typical digital objects include JPEG files, MPEG files, MP3 files, GIF files, and so on.

“Transcode” means reconfiguring a digital object or file into a form or format suitable for display on a particular display device. MPEG files, for example, are ‘transcoded’ to have frame rates suitable for a particular video display. JPEG files, for example, are ‘transcoded’ to fit the screen size of a particular bit mapped computer screen. Many means and methods of transcoding will occur to those of skill in the art, and all such means and methods are well within the scope of the present invention.

A “transcoding gateway” is a server capable of transcoding messages from one format to another, as for example, from email objects to files stored in file systems or from digital object in emails to transcoded digital object suitable for display upon display devices, including for example, video screen, audio players, digital art frames, television sets controlled by set top boxes, text to speech converters in automobiles, and so on. Transcoding gateways are “gateways” in the sense that they carry out their server functions by use of than one protocol, as for example, a transcoding gateway that receives email messages using POP and distributes digital objects in HTML documents using HTTP. Transcoding gateways also are ‘gateways’ in the sense that they implement uplinks between LANs and WANs; in many embodiments, a WAN so uplinked is an Internet.

“URL” means Uniform Resource Locator, the standard method of associating World Wide Web data locations with network addresses for data communications. A URL typically includes an internet protocol address, or a domain name that resolves to an internet protocol address, identifying a location where a resource is located on a network. URLs directed to particular resources, such as particular HTML files, JPEG files, or MPEG files, typically include a path name or file name locating and identifying a particular resource in a file system coupled to a network. To the extent that a particular resource, such as a CGI file or a servlet, is executable, a URL often includes execution parameters.

“WAN” means wide area network.

“World Wide Web,” or more simply “the web,” refers to the well-known system of internet protocol (“IP”) servers that support specially formatted documents, documents formatted in a language called “HTML” for HyperText Markup Language. The term “Web” is used in this specification also to refer to any server or connected group or interconnected groups of servers that implement the HyperText Transport Protocol, “HTTP,” in support of URLs and HTML documents, regardless whether such servers or groups of servers are coupled to the world wide web as such.

“TDMA” stands for Time Division Multiple Access, a technology for delivering digital wireless service using time-division multiplexing. TDMA works by dividing a radio frequency into time slots and then allocating slots to multiple calls. In this way, a single frequency can support multiple, simultaneous data channels. TDMA is used by GSM.

“GSM” stands for Global System for Mobile Communications, a digital cellular standard. GSM at this time is the de facto standard for wireless digital communications in Europe and Asia.

“CDPD” stands for Cellular Digital Packet Data, a data transmission technology developed for use on cellular phone frequencies. CDPD uses unused cellular channels to transmit data in packets. CDPD supports data transfer rates of up to 19.2 Kbps.

“GPRS” stands for General Packet Radio Service, a standard for wireless data communications which runs at speeds up to 150 Kbps, compared with current GSM systems which cannot support more than about 9.6 Kbps. GPRS, which supports a wide range of speeds, is an efficient use of limited bandwidth and is particularly suited for sending and receiving small bursts of data, such as e-mail and Web browsing, as well as large volumes of data.

“EDGE” stands for Enhanced Data Rates for GSM Evolution, a standard for wireless data communications supporting data transfer rates of more than 300 Kbps. GPRS and EDGE are considered interim steps on the road to UMTS.

“UMTS” stands for Universal Mobile Telecommunication System, a standard for wireless data communications supporting data transfer rates of up to 2 Mpbs. UMTS is also referred to W-CDMA for Wideband Code Division Multiple Access.

“Bluetooth” refers to the Bluetooth Specification, a specification for short range radio links among mobile personal computers, mobile phones, and other portable devices.

“802.11(b)” refers to IEEE standard number 802.11(b), a standard of wireless local area network communications.

“HomeRF” refers to the Home Radio Frequency LAN standard promulgated by the HomeRF Working Group. HomeRF is designed to be more affordable for homes, as contrasted with 802.11(b) which was designed for business use.

A “service gateway” is an OSGI-compliant host server, server software installed and running on server computer hardware. “OSGI” refers to the Open Services Gateway Initiative, a computing industry organization developing specifications for service gateways, including specifications for delivery of “service bundles.” OSGI service bundles are software middleware providing compliant data communications and services through service gateways. The Open Services Gateway specification is a java based application layer framework that gives service providers, network operator device makers, and appliance manufacturer's vendor neutral application and device layer APIs and functions. An “API” is an Application Program Interface, a set of routines, protocols, and tools for building software applications.

A service gateway often is a home or business server, a separate computer coupled for data communications through a local area network or “LAN” to client devices. Client devices include any device capable of adaptation for data communications, including for example, automobiles, vending machines, cash registers, gasoline pumps, RFID readers, clocks, window shade controllers, door locks, smoke detectors, proximity detectors, television sets, radios, electric light switches, thermostats, thermometers, air conditioners, heaters, medical monitoring equipment, refrigerators, cook tops on stoves, ovens, coffee makers, water heaters, and so on.

A service gateway often is an embedded server inserted in a LAN not only for providing data communications among client devices, but also to connect a wide area network or “WAN,” such as an external internet or extranet, to internal client devices within a home, office, or business setting. A service gateway sometimes is an embedded server installed and running in the same physical device or cabinet with a client device.

“Embedded server” means a Java embedded server, a small-footprint application server that can be embedded in any networked device, home gateway, or client device.

Embedded servers typically are zero-administration devices intended, when implemented as service gateways, to divide a network architecture into an external WAN and an internal LAN. An embedded server manages services deployed from trusted external resources to internal client devices over a network, including for example, services implemented through OSGI-compliant service bundles. Embedded servers enable deployment and installation of services, such as OSGI-compliant service bundles, on a just-in-time basis, when the services are needed from time to time for use by client devices.

### DETAILED DESCRIPTION

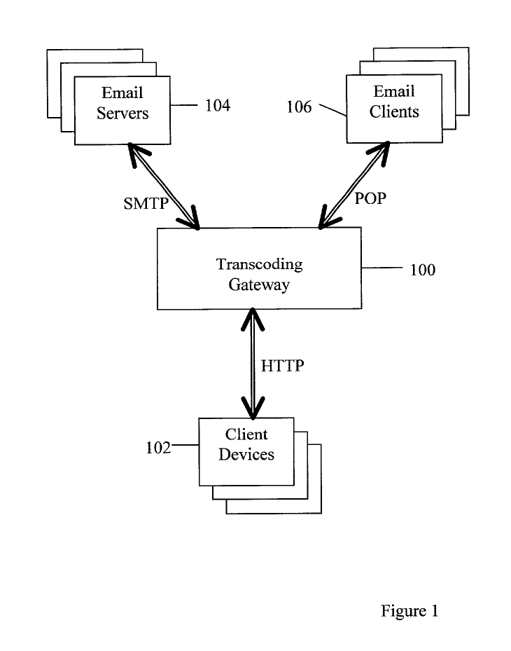

Turning now to FIG. 1, a first aspect of the invention is seen illustrated as a transcoding gateway configured to accept email from email servers (104), deliver the email to email clients (106), and transcode and deliver digital objects from the email to client devices (102). The embodiment illustrated in FIG. 1 comprises a ‘gateway’ in the sense of providing connections among more than one protocol, in the illustrated example embodiment, SMTP for receipt of email from other servers, POP for delivery of email to email clients, and HTTP for delivery of digital objects to client devices.

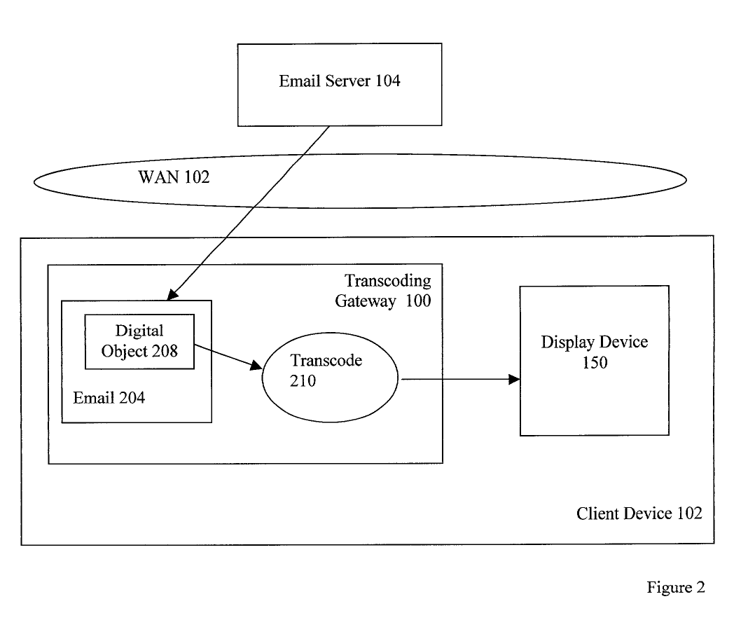

Turning to FIG. 2, an additional example embodiment is illustrated in which a client device comprises a transcoding gateway and a display device. In typical embodiments according to FIG. 2, email (204) bearing digital objects (208) is received in a transcoding gateway (100). The digital objects are transcoded (210) into a format suitable for display and then displayed on one or more display devices (150). Exemplary embodiments according to FIG. 2 include client devices that are set top boxes on televisions. In such embodiments, display devices include video monitors and audio players, and digital objects include video clips, audio files, graphic images, text to speech files, and text overlays.

In typical embodiments, digital objects are embedded or attached to email in the form of digital files having display format types, whose display format types are often indicated in a file name extension. Video files, for example, often have file names like MyFile.MPEG, where MPEG is a file name extension identifying the display format of a video file. Audio files, for example, often have file names like MyFile.MP3, where MP3 is a file name extension identifying the display format of an audio file. Image files, for example, often have file names like MyFile.GIF, where GIF is a file name extension identifying the display format of an image file. Image files, as another example, often have file names like MyFile.JPEG, where JPEG is a file name extension identifying the display format of an image file.

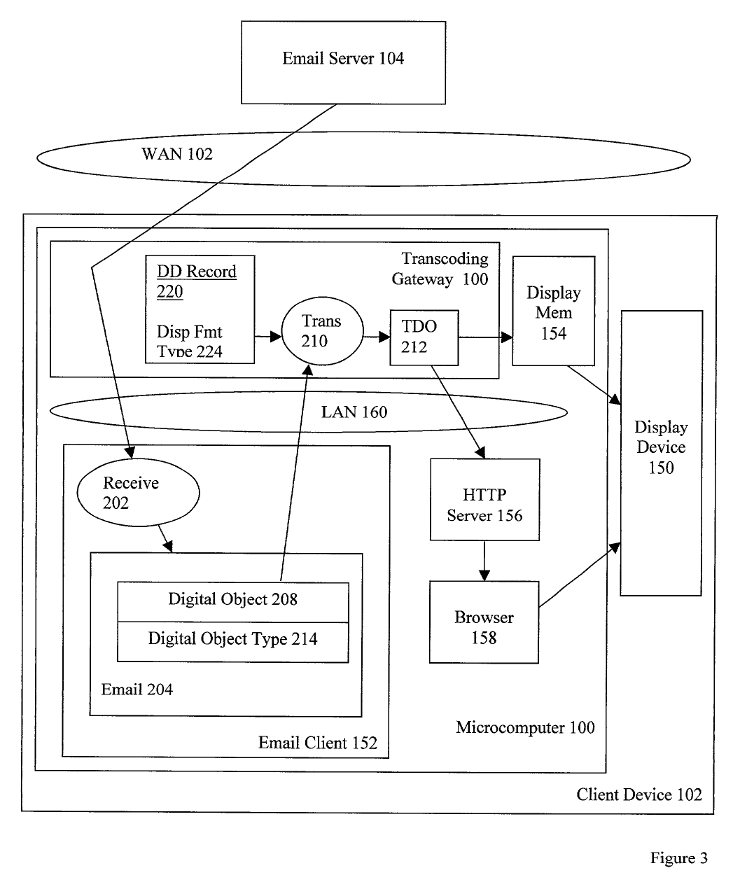

Turning to FIG. 3, a further embodiment is seen illustrated as a method of email administration, in which the method is implemented within and upon a client device (102), the client device comprising a transcoding gateway (100), the transcoding gateway comprising display device records (220) stored in computer memory, each display device record representing a display device (150) (one shown). In the illustrated embodiment, the display device record (220) includes a display format type (224), that is, a field or attribute that identifies a display format type supported by the display device represented by the display device record. More specifically, in embodiments according to FIG. 3, the transcoding gateway often includes, for each display device, a display device record (220) comprising display format attributes (240) of each display device, wherein the display format attributes include a display format type (224) for each display device.

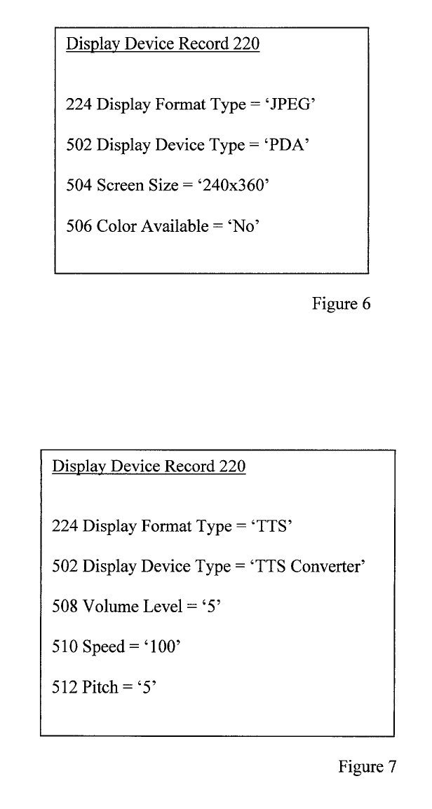

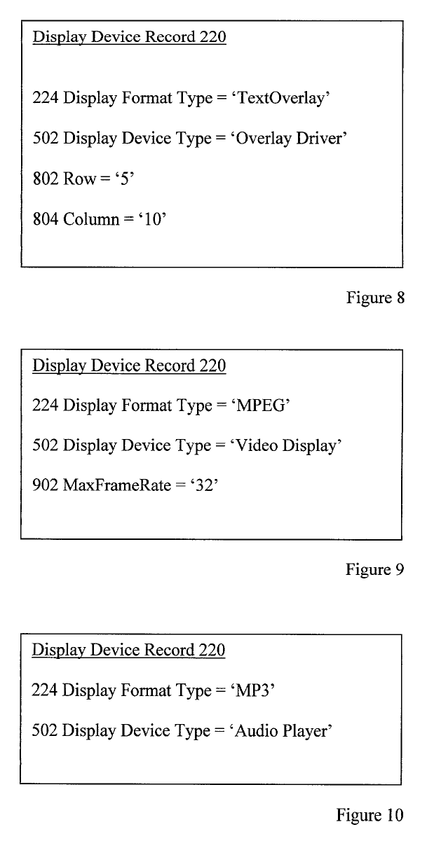

FIGS. 6-10 illustrate several examples of more detailed display device records (220). As shown in FIGS. 6-10, it is usual in various embodiments of the invention for display device records (220) to include an attribute identifying the display device type (502), as well as other attributes for use in transcoding digital objects into formats suitable for display on a particular type of client device. FIG. 6, for example, illustrates a display device record for a personal digital assistant or “PDA,” having a screen size (504) limited to only 240×360 pixels with no color capability (506). FIG. 7 illustrates an example display device record for a text to speech converter (502) with default transcoding support attributes for volume level scaled 1 to 10 (508), speech speed in word per minute (510), and speech pitch on a scale of 1 to 10 (512). FIG. 8 illustrates an example display device record representing a text overlay driver (502) having transcoding support attributes identifying the row (802) and column (804) of the screen position for text display. FIG. 9 illustrates an example display device record representing a video display (502) with a transcoding support attribute identifying the maximum frame rate of the display (902). FIG. 10 illustrates an example display device record representing an audio player (502) for MP3 files (224). From this discussion and the drawings, it is now clear that many alternative forms of display device records will occur to those of skill in the art and that all such forms are well within the scope of the present invention.

As readers will understand from the discussion of embodiments illustrated by FIGS. 6-10, client devices are included in any physical device capable of supporting a coupling for data communications to an email server. Client devices include set top boxes for television sets, the set top boxes coupled to email servers through wide-band cable network connections. Client devices include digital art frames coupled through OSGI-compliant service gateways to wideband Internet connections. In some embodiments, transcoding gateways include OSGI-compliant service bundles downloaded to microcomputers on client devices through OSGI-compliant service gateways. Transcoding gateways implemented by use of OSGI-compliant service bundles typically include a JAVA installation on a microcomputer on a client device; in some exemplary embodiments of this kind, using OSGI-compliant service bundles, the transcoding gateway itself optionally is implemented as a JAVA embedded server.

Client devices include automobiles having integrated display devices comprising text to speech converters, wherein a microcomputer implements a wireless network coupling to an email server. Client devices include PDAs and network-enabled cellular telephones that implement wireless network couplings to email servers. Many other client devices capable of supporting couplings for data communications with email servers will occur to those of skill in the art, all such client devices being well within the scope of the present invention. Wireless network couplings to email servers include wireless couplings implemented by use of, for example, TDMA, GSM, CDPD, GPRS, EDGE, UMTS, Bluetooth, 802.11b, and HomeRF. Other wireless network couplings will occur to those of skill in the art. The use of any wireless network coupling is well within the scope of the present invention.

Embodiments according to FIG. 3 typically include receiving (202) through a transcoding gateway (100) an email message (204), wherein the email message comprises at least one digital object (208) having a digital object type (214). In embodiments of the kind illustrated, receiving an email message typically includes receiving an email message by use of a standard email protocol. Examples of email protocols useful for receiving email messages in various embodiments of the invention include SMTP and POP3. Persons of skill in the art will identify other email protocols useful for receiving email messages in various embodiments of the invention, the use of all such email protocols being well within the scope of the present invention.

In such embodiments, the transcoding gateway (100) typically is coupled to one or more display devices. The coupling between the transcoding gateway and a display device in some embodiments is more or less direct, such as for example, a segment of computer memory reserved as display memory (154) to which the transcoding gateway directly writes digital objects for use by the display device (150). Other embodiments include more or less indirect couplings between a transcoding gateway (100) and a display device (150) as a browser (158) to which transcoded digital objects are sent as digital files for display. Browsers support applets and plug-ins capable of displaying a wide variety of digital formats. Browsers typically display, for example, text, graphics, audio and video.

Embodiments according to FIG. 3 typically include finding (210) a display device record for a destination display device (150), wherein the destination display device (150) comprises a display device having a display format type (224) that is the same as the digital object type (214), and transcoding the digital object (210) in dependence upon the display format attributes (240) of the destination display device. Such embodiments include displaying (210) the transcoded digital object (212) on a destination display device (150).

Some embodiments, as shown in FIG. 3, include within a client device a display device (150) and a microcomputer (100), so that the microcomputer further includes a transcoding gateway (100), an email client (152), a web browser (158), and an HTTP server (156), wherein the transcoding gateway, the email client, the web browser, and the HTTP server are coupled for data communications (160). In this context, ‘coupled for data communications’ means coupled through a LAN implemented on the same microcomputer, so that data communications among the transcoding gateway, the email client, the browser and the HTTP server are carried out in some standard protocol such as the internet protocol, for example. This kind of embodiment has the advantage of using some components available more or less ‘off the shelf,’ as are email clients, browsers, and HTTP servers.

In this kind of embodiment, as shown in FIG. 3, an email client (204) receives (202) email directly from an email server (104) across a WAN (102) such as, for example, the Internet. This kind of embodiment illustrates another sense in which the transcoding gateway is a ‘gateway,’ that is, in that the transcoding gateway (100) implements an uplink between a LAN (160) and a WAN (102).

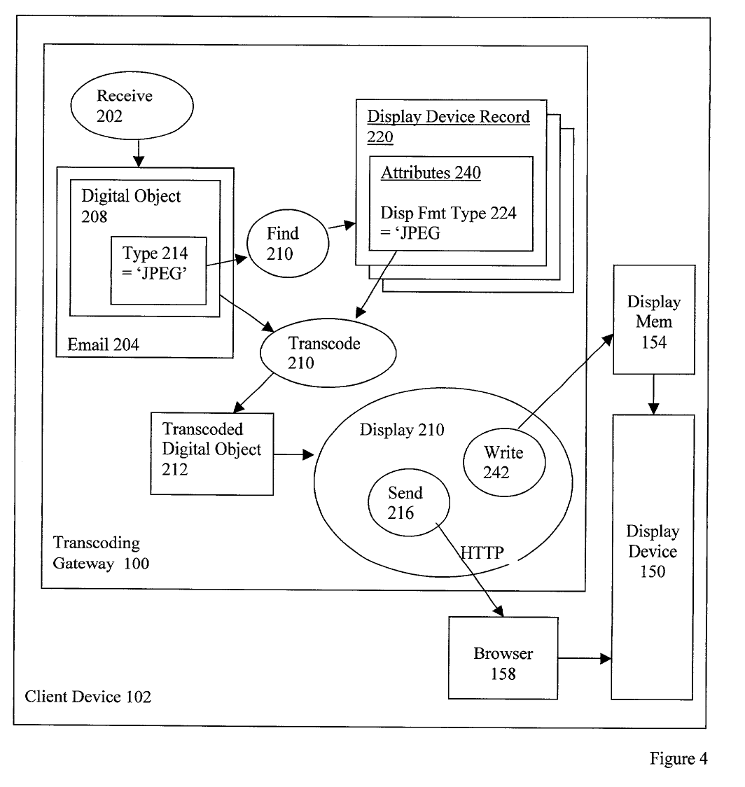

In other embodiments, the transcoding gateway itself includes an email client (150), a web browser (158), and an HTTP server (156). FIG. 4, for example, illustrates an embodiment in which email (204) is received directly within a transcoding gateway (100). In the embodiment of FIG. 4, an HTTP service function is implemented by sending (216) transcoded digital objects (212) to a browser (158) via HTTP. In embodiments according to FIG. 4 displaying (210) a transcoded digital object (212) on a destination display device (150) often includes writing the transcoded digital object to display memory (154). In such embodiments, displaying (210) the transcoded digital object (212) on the destination display device (150) often includes sending (216) the transcoded digital object to a browser.

Embodiments according to FIG. 4 have the advantage that the email client functionality and HTTP server functionality in such embodiments is relatively simple compared to the usual full-blown email clients and web servers familiar in the art. Email clients in such embodiments, for example, need only implement sufficient functionality to download email messages from an email server using a standard protocol, such as POP or POP3, and make included digital objects accessible to the transcoding function (210) by, for example, storing included digital objects in a known or predetermined memory location. For such email clients most elements of standard email clients would be entirely optional, including most aspects of user interface, provisions for user manipulation of long term storage of email, provisions for elaborate user help systems, and provisions for user customization of functionality.

Use of such simplified email clients eases the cost of development and manufacture of some embodiments of the present invention. It is an engineering decision in particular embodiments whether to develop a simplified email client or to take an existing email client and implement it, for example, in firmware embedded in a microcomputer in a client device. In some embodiments, for example, a simplified email client is adequate in functionality, less expensive to manufacture, but more expensive to develop than an ‘off the shelf’ email client. Similar software engineering considerations naturally apply to many elements of various embodiments.

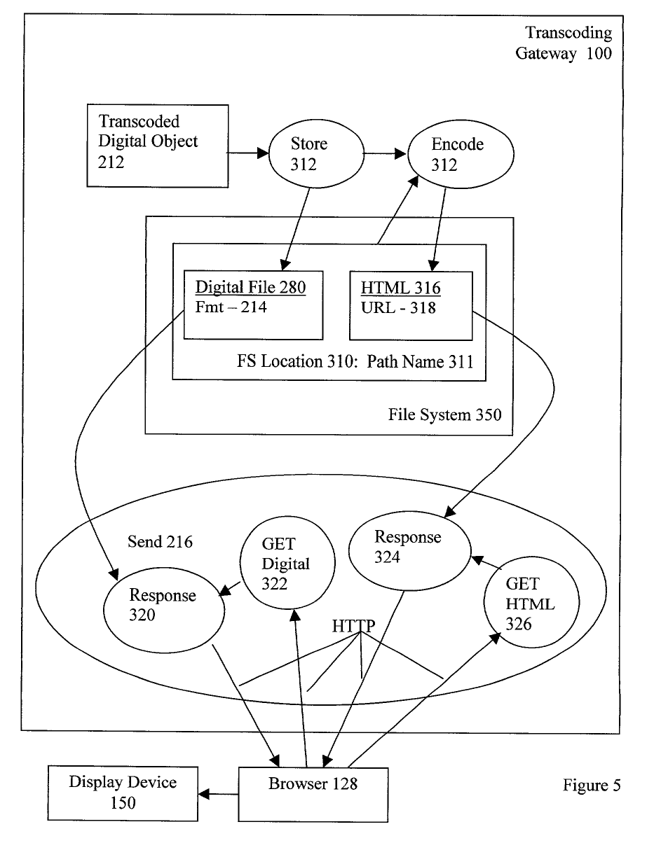

HTTP service, for example, in some embodiments is limited so as to conserve costs of development and manufacture. Turning to FIG. 5, for example, a further embodiment is illustrated including a file system (350), the file system including file system storage locations (310), each file system storage location having a path name (311). FIG. 5 shows a more detailed example embodiment in which HTTP functionality within a service gateway is included in the send function (216) for transmitting digital files to a browser (128).

In the example embodiment of FIG. 5, digital files (270) are forms of transcoded digital objects (212) stored (312) in computer memory in a file location (310) in a file system (350) included in or accessible through the transcoding gateway (100). Even more specifically, in the example embodiment of FIG. 5, the browser (128) sends an HTTP ‘get’ message (326) to the transcoding gateway and receives an HTTP ‘response’ message (324) forwarding an a URL (318) encoded (312) with the file system location (310), including the path name (311), where the digital file (280) is stored. The browser uses the URL in another HTTP ‘get’ message (322) requesting the digital file (212) which is downloaded to the browser in a second HTTP ‘response’ message (320). Embodiments of this kind need only very thin HTTP service, just enough to exchange a handful of predetermined message types with a browser.

Typical embodiments of the invention are operative for display devices that are audio players and the display format type ‘MP3.’ Typical embodiments of the invention are operative for display devices that are video players and the display format type ‘MPEG.’ Typical embodiments of the invention are operative for display devices that are ‘digital picture frames’ or ‘digital art frames’ and the display format type ‘JPEG.’ Typical embodiments of the invention are operative for display devices that are ‘digital picture frames’ or ‘digital art frames’ and the display format type ‘GIF.’ Many other combinations of display device and display format type will occur to those of skill in the art, all such combinations being perfectly useful within the scope of the present invention.

While embodiments have been described for email comprising digital objects having the display format types JPEG, MPEG, MP3, and GIF, among others, for example, persons skilled in the art will recognize many alternative digital formats that are useful with the invention, all such digital formats being well within the scope of the invention. While embodiments of the inventions have been described generally in terms of HTTP and HTML as they are often associated with URL processing in the Web, those skilled in the art will readily appreciate that other internet protocols are known and are adaptable to the teachings of the invention. Many such adaptations will occur to those of skill in the art, all such adaptations being well within the scope of the present invention.

Advantages of the present invention include the following:

A user of an embodiment of the invention is capable of emailing a recipe and a text-to-speech file to the grandmother's kitchen stove, where the recipe is then stored in computer memory on the stove and a text-to-speech converter orally announces to grandmother the arrival of the new recipe; in this example, the email address of grandmother's kitchen stove is “kitchenstove@grandmothershouse.net.”

A user of an embodiment of the invention, knowing the dangers of trying to read an email message and drive at the same time, is able to email to his wife's car a text-to-speech file asking his wife to meet him for lunch; the email address is “mywife@hercar.net.”

A boy scout troop leader emails directly to digital art frames in the home of each member of his scout troop graphic image files of snapshots from summer camp.

An avid amateur guitar player emails directly to a friend's sound system an MP3 recording of a new performance by the guitar player.

It is clear from the foregoing descriptions that many modifications and changes may be made in the exemplary embodiments of the invention without departing from its true spirit. The descriptions in this specification are for illustration only and are not to be construed in a limiting sense. The scope of this invention is limited only by the language of the following claims.

What is claimed is:

1. A method of email administration comprising the steps of:
receiving through a transcoding gateway an email message, wherein
the email message comprises at least one digital object having a digital object type;
the transcoding gateway is coupled to one or more display devices, and
the transcoding gateway comprises, for each display device, a display device record comprising display format attributes of each display device, wherein the display format attributes include a display format type for each display device;
finding a display device record for a destination display device, wherein the destination display device comprises a display device having a display format type that is the same as the digital object type;
transcoding the digital object in dependence upon the display format attributes of the destination display device; and
displaying the transcoded digital object on the destination display device.

2. The method of claim 1 wherein the transcoding gateway comprises an email client, a web browser, and an HTTP server.

3. The method of claim 1 wherein the client device comprises a display device and a microcomputer, wherein the microcomputer further comprises the transcoding gateway, an email client, a web browser, and an HTTP server, wherein the transcoding gateway, the email client, the web browser, and the HTTP server are coupled for data communications.

4. The method of claim 1 wherein displaying the transcoded digital object on the destination display device further comprises writing the transcoded digital object to display memory.

5. The method of claim 1 wherein displaying the transcoded digital object on the destination display device further comprises sending the transcoded digital object to a browser.

6. A system for email administration comprising:
means for receiving through a transcoding gateway an email message, wherein
the email message comprises at least one digital object having a digital object type;
the transcoding gateway is coupled to one or more display devices, and
the transcoding gateway comprises, for each display device, a display device record comprising display format attributes of each display device, wherein the display format attributes include a display format type for each display device;
means for finding a display device record for a destination display device, wherein the destination display device comprises a display device having a display format type that is the same as the digital object type;
means for transcoding the digital object in dependence upon the display format attributes of the destination display device; and
means for displaying the transcoded digital object on the destination display device.

7. The system of claim 6 wherein the transcoding gateway comprises an email client, a web browser, and an HTTP server.

8. The system of claim 6 wherein the client device comprises a display device and a microcomputer, wherein the microcomputer further comprises the transcoding gateway, an email client, a web browser, and an HTTP server, wherein the transcoding gateway, the email client, the web browser, and the HTTP server are coupled for data communications.

9. The system of claim 6 wherein means for displaying the transcoded digital object on the destination display device further comprises means for writing the transcoded digital object to display memory.

10. The method of claim 6 wherein means for displaying the transcoded digital object on the destination display device further comprises means for sending the transcoded digital object to a browser.

11. A computer program product for email administration comprising:
a recording medium;
means, recorded on the recording medium, for receiving through a transcoding gateway an email message, wherein
the email message comprises at least one digital object having a digital object type;
the transcoding gateway is coupled to one or more display devices, and
the transcoding gateway comprises, for each display device, a display device record comprising display format attributes of each display device, wherein the display format attributes include a display format type for each display device;
means, recorded on the recording medium, for finding a display device record for a destination display device, wherein the destination display device comprises a display device having a display format type that is the same as the digital object type;
means, recorded on the recording medium, for transcoding the digital object in dependence upon the display format attributes of the destination display device; and
means, recorded on the recording medium, for displaying the transcoded digital object on the destination display device.

12. The system of claim 11 wherein the transcoding gateway comprises an email client, a web browser, and an HTTP server.

13. The system of claim 11 wherein the client device comprises a display device and a microcomputer, wherein the microcomputer further comprises the transcoding gateway, an email client, a web browser, and an HTTP server, wherein the transcoding gateway, the email client, the web browser, and the HTTP server are coupled for data communications.

14. The system of claim 11 wherein means for displaying the transcoded digital object on the destination display device further comprises means, recorded on the recording medium, for writing the transcoded digital object to display memory.

15. The method of claim 11 wherein means for displaying the transcoded digital object on the destination display device further comprises means, recorded on the recording medium, for sending the transcoded digital object to a browser.
